(19) United States
(12) Patent Application Publication
(10) Pub. No.: US 2011/0028304 A1
(43) Pub. Date: Feb. 3, 2011

(54) CERAMIC MASS FOR BRICK MAKING AND WAY OF PRODUCTION

(76) Inventors: Dmitry Vasilievich Somichev, St. Petersburg (RU); Elena Alekseevna Popova, St. Petersburg (RU); Galiya Sibgadulovna Skok, St. Petersburg (RU); Anatoly Ivanovich Potapov, St. Petersburg (RU)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 12/747,690

(22) PCT Filed: Sep. 22, 2008
(86) PCT No.: PCT/RU08/00609

§ 371 Date: Sep. 2, 2010

(30) Foreign Application Priority Data
Dec. 11, 2007 (RU) 2007146091

(51) Int. Cl. C04B 33/04; C04B 33/00; C04B 33/32

(52) U.S. Cl. 501/149; 501/141

(57) ABSTRACT

CERAMIC PASTE FOR BRICK MANUFACTURING and way of production. CERAMIC PASTE FOR BRICK MANUFACTURING and way of production deals with the construction material industry, specifically with the construction wall brick manufacturing, made at the thermo burning temperature reduction. The paste is being created on the clay base. The 5% water copolymer solution of menthylmetacrylat (MMA) with 73-80% methacrylic acid with molecular mass 800 000 is used as and additive, the component proportions, mass %: Clay —75-81% 5% water copolymer solution of menthylmetacrylat (MMA) with 73-80% methacrylic acid with molecular mass 800 000—1-3 Water—the other part. The essence of the method—muffle stove burning is made with the following regime: w temperature growth up to 800° C. within 3 hours, 2 hours of exposure at the temperature 800° C. and cooling process within 15 hours. Time of brick exposure at the stove is reduced for 10-30% in comparison with the existing burning technology. The invention gives the possibility of low temperature brick burning gaining, that leads to the power energy consumption reduction at the brick manufacturing. The plasticity of paste is also increased and the other properties of ready articles are preserved.

### FIELD OF TECHNIQUE

The invention deals with the field of construction material manufacturing, specifically for wall construction brick manufacturing.

### BACKGROUND OF THE INVENTION

Nowadays for the reduction of burning temperatures at the ceramic articles manufacturing the forming pastes are filled with different additives: dolomite powder, nonplastic materials, waists of different productions—coal-mining, plant oils production, benzosulphoacids with olygophurphuroxyloxan and the others.

The composition for brick manufacturing with the inclusion of coal-mining waists is known. (Caligarise E E.//Tile and brick Jnt/-1990-6 N^{o} 4, pages 41-42, //magazine “Chemistry”, 1990, 8M, 220)

Additional inclusion of hard components into the forming paste with the aim of burning temperature reduction didn't allow keeping and improving the brick quality at the burning temperature 500-800 degrees C., even when use the squeeze ramming at the pressure of 20-80 MPA. Mechanical strength was 10-18 MPa.

“The ceramic paste for hard brick manufacturing” with the inclusion of clay component, quartz sand, surface active additive agent and water is also known (Certificate of authorship USSR N^{o} 1662984, C 04 B 33/00. priority 1 Nov. 1988, published 15 Jul. 1991), as a clay component the paste contains clay, and as a surface active additive—soap stock, that is the waist of plant oil production, with the proportion of the components, mass %:

| | |
|---|---|
| Clay | 45.34-49.37 |
| QUARTZ sand | 27.21-29.63 |
| Soap stock - plant oil | 0.05-0.4 |
| production waists | |
| Water | The other part |

The invention is aimed at the increasing of mechanical failure resistance and reduction of water absorption with the simultaneous increasing of raw paste ductile ness. This type of the ceramic paste allows manufacturing of the high quality brick.

But the process of manufacturing demands rather high burning temperatures 980-1020 Degrees C., that causes high power consumption at the brick manufacturing.

“Ceramic paste for wall construction ceramic articles manufacturing” (Certificate of authorship

USSR N^{o} 922098, priority 24 Jan. 1980, published 23 Apr. 1982) is the closest to the offered technical decision from the point of view of technical body and achieved effect. It is chosen as a genus proximus and includes plastic clay, nonplastic material and in addition the electrochemical production waists with the proportions of the components, mass %

| | |
|---|---|
| Plastic clay | 68-80 |
| Nonplastic material | 15-30 |
| Electrochemical production | 2-5 |
| waists based on Ca | |
| hydroxide and Si dioxide | |

The electrochemical production waists are added into the paste for burning temperature reduction and total contraction decreasing with preserving of durability of articles.

The disadvantage of the ceramic paste is rather high temperature of burning 920-980 0° C., that leads to great energy resources consumption at the articles manufacturing and to limiting in using the less plastic clays and using the ecologically dangerous additives.

Besides, the increasing of power consumption is influenced by another thermo burning parameter—holding time of patterns at the maximum temperature.

It is well known, that the imperceptible burning temperature reduction always demands the great exposure time growth for keeping the quality of the end products.

The ceramic articles way of preparation is known, mainly for lining brick (License RF N^{o} 2095329, “Ceramic wall articles and its preparing of clay-sand mixtures”, C 04 B 33/00, C 04B 33/02, priority 5 Aug. 1996, published 10 Nov. 1997), which includes the preparing of a raw mix by dissolution and dispergation of a clay component at 200-300° C., mixing of clay component, quartz sand and coal clay as well as humidifying, biscuit press forming, drying and burning with isothermal exposure.

The mix is granulated up to specific surface area 2000-7000 sm²/g, humidified with caustic soda solution, the raw mix contains, mass

| | |
|---|---|
| Clay component | 50 85 |
| Quartz sand | 3 40 |
| Coal clay | 5 15 |
| Caustic soda (in conversion to Na₂O) | 0.2 15 |

And made burning with the isothermal exposure at 950-1000° C. during 3-5 hours.

As a result of using the method, they get the articles with rather high physic-mechanical figures and the energy capacity power consumption reduction of the technological process is gained.

But the burning process is made with the isothermal exposure at 950-1000° C. during 3-5 hours that is the index of rather high energy capacity power of the technological process of the method.

The method of facing ceramic articles manufacturing (certificate of authorship USSR N^{o} 1390216, C04B 33/02, priority 14 Nov. 1986, published 23 Apr. 1988) is the closest to the offered technical decision from the point of view of technical implication and achieved effect.

It is chosen as a prototype, where mixing of components is made with 3 stages, 15-25% of clay mass, 50-60% of water and the solution of Benz sulfur acid in acetone (the party of acetone is 0.8-1.0 mass % and bensosulfoacid is 0.1-0.15 mass % of water amount in mix) as an organic component are mixed during 3-4 minutes at the first stage,

The total mixing of components is made at the 3-d stage.

The invention is aimed at the increasing of durability and cold-resistance and reduction of water absorption.

But the disadvantage of the method is rather high burning temperature, 850-900° C. and time of exposure—28-30 hours.

### DISCLOSURE OF THE INVENTION

The present invention is aimed at the manufacturing of the ceramic paste of the extra ductiliness with preserving all the properties of the ready article.

As a result of the researched method the reduction of burning temperature and time of exposure at the stove are gained as well as reduction of power consuming at the wall brick manufacturing.

The essence of the invention is the following, the ceramic paste for brick manufacturing with the inclusion of clay and additives is added with 5% water solution of copolymer menthylmetacrylat (MMA) with 73-80% metacryl acid (MK) with molecular mass 800 000, at the proportion of the components, mass %

| | |
|---|---|
| Clay | 75-81 |
| 5.0% water solution of copolymer (MMA) | 1-3 |
| With 73-80% (MK) molecular mass 800 000 | |
| Water | All other part |

The brick manufacturing method is provided with the way of mixing clay, water and different additives, biscuit forming, drying and burning.

Mixing of components is made with the proportion 75-81 mass % clay, 20-25% mass water of all mix and 5.0% water solution of copolymer MMA with 73-80% MK molecular mass 800000 is added simultaneously.

The burning of biscuits goes at the slow temperature being rosen up to 800° C. during 3 hours, following by the exposure during 2 hours at the temperature 800° C. and cooling during 15 hours.

The composition made on the base of clay and the method of preparation gives the possibility of the low temperature brick burning.

The new component of mix—copolymer is ecologically pure ready-mixed substance. Its technical name is Methacryl 14. The burning copolymer evolves only CO₂.

Physicochemical properties of the copolymer with the average molecular mass 800000 are presented at the table 1.

The basic product Methacryl-14 is used at the compositions for the extrusion forming of construction articles with the aim of water absorption reduction. (Certificate of authorship USSR N^{o} 1638130, C 04B 28/08, priority 15 Nov. 1988, published 30 Mar. 1991)

IT is used in the offered paste as water solutions. It is possible to use both quarry clay (humidity 18-24%) and dry clay, previously disintegrated, for paste cooking. In this way the previous humification of dry clay is not needed, the copolymer solution is added immediately.

Water copolymer solution using allows to process clays of different quality with plasticity from 6, 2 and more. Copolymer adsorption on the surface of hard pieces and its homogeneous allocation within all mass volume increases the clay plasticity on the stage of mixing, that aids in extra hard structure creating on the drying stage and in quicker fragment forming at the temperature 800° C. during 2 hours.

The exposing time growing at 800° C. practically doesn't improve the physic-chemical properties of the ready articles.

The mixtures are made with the simple mixing of components. The patterns with the sizes of side 60-52 mm are being formed with the received pastes (humidity 18-25%) and being dried with the regular method until humidity not more that 2% and being burnt at the muffle stoves at the following regime; slow temperature rising up to 800° C. within 3 hours, exposure within 2 hours at 800° C. and cooling within 15 hours.

At the plant environments the time of exposure at the stove can be reduced for 10-13% to compare with the existing burning technology at the plant.

The optimum quantity of copolymer water solution additives is 1-3 mass %. Adding of less then 1 mass % doesn't provide the necessary forming paste plasticy and article hardness at the temperature 800° C., i.e. the higher burning temperature is needed.

Adding of more than 3 mass % of copolymer water solution doesn't cause the further temperature reduction and could cause the appreciation of the final article.

### INVENTION REALIZING VARIANTS

The examples of invention realizing are given at the Table 2 and Table 3.

Ceramic paste compositions on the clay base are given at the Table 2.

The Table 3 shows the burnt patterns properties in dependence with paste composition, burning temperature, time of exposure at the maximum temperature, that were made of given clay paste in comparison with the prototype,

Table of symbols:

OY—common contraction, %

B [symbol] —water absorption, %

Q_{c} [symbol] —breaking strength at compression, MPa

Q [symbol] ₃ᵣ—breaking strength at bending, MPa

The Table 3 shows, that patterns made of given paste and burnt at the temperature 800° C. and exposure within 2 hours, didn't deprave the physic-chemical properties in comparison with the patterns, received with the prototype, but burnt at the higher temperature, at 920° C.

In this way, in comparison with the prototype the lower burning temperature for the given clay paste is achieved, that is caused by its new components, with preserving of the other physic-mechanical brick properties.

### INDUSTRIAL APPLICABILITY

Industrial Applicability of the offered invention at the clay brick manufacturing allows to reduce the power energy consumption dramatically, as the given ceramic clay paste is created for the low temperature brick burning.

Brick burning temperature reduction, specifically not higher then 800° C., causes also the reduction of ready article cost price, but gives the certain ecological advantages (N oxides, S and C release environmental reduction).

Fight with the releases also causes the appreciation of manufacturing.

TABLE 1
Physic-chemical copolymer properties

| | | | | Methacryl acid |
|---|---|---|---|---|
| | | Density, | | contain, |
| Type | TC | kg/m3 | Chemical formula | mass % |
| Methacryl-14 | 6-01- 1070-90 | 1206 | 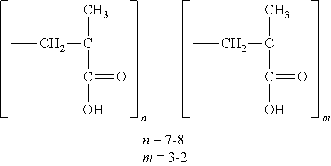 | 73-80 |

TABLE 2
Ceramic paste compositions based on clay

| | composition, mass. % | | |
|---|---|---|---|
| components | 1 | 2 | 3 |
| Clay | 75 | 78 | 81 |
| Additive | 3 | 2 | 1 |
| 5 mass % | | | |
| Copolymer water | | | |
| solution | | | |
| Water | 22 | 20 | 18 |

TABLE 3
Burnt patterns properties on prototype and offered invention
On prototype

| | | | | Burning 920° C. | | | | |
|---|---|---|---|---|---|---|---|---|
| | | | | Time of exposure - not given | | | | |
| | Composition, | | | | | | | σ. |
| | mass % | | | No of | | | σ. [symbol] | [symbol] |
| Components | No 3 | No 4 | No 5 | composition | OY, % | B [symbol] , % | M [symbol] a | Mna |
| Plastic clay | 68.0 | 76.5 | 80.0 | 3 | 4.3 | 20 | 26.26 | Not |
| | | | | | | | | given |
| Additives: | 30.0 | 15.0 | 30.0 | 4 | 4.0 | 19 | 29.10 | [symbol] |
| nonplastic | | | | | | | | |
| material | | | | | | | | |
| Electrochemical | 2.0 | 3.5 | 5.0 | 5 | 4.7 | 18 | 31.92 | [symbol] |
| production | | | | | | | | |
| waists | | | | | | | | |

On the offered invention

| | | | | Burning 800° C. | | | | |
|---|---|---|---|---|---|---|---|---|
| | No 1 | No 2 | No 3 | Time of exposure - 2 hours | | | | |
| Clay | 75.0 | 78.0 | 81.0 | 1 | 4.4 | 18.1 | 30.2 | 11.8 |
| Additive | 3.0 | 2.0 | 1.0 | 2 | 4.2 | 18.8 | 29.9 | 11.7 |
| 5% copolymer | | | | | | | | |
| water solution | | | | | | | | |
| Water | 22.0 | 20.0 | 18.0 | 3 | 4.6 | 19.2 | 26.8 | 10.4 |

1. Ceramic paste for brick manufacturing, with inclusions of clay, additive, differs with the fact, that as an additive the copolymer menthylmetacrylat (MMA) with 73-80% methacryl acid (MK) with molecular mass 800 000 5% water solution is used, the mass proportion %;

| | |
|---|---|
| Clay | 75-81 |
| Copolymer 5% water solution (MMA) | 1-3 |
| with 73-80% (MK) with molecular mass 800 000 | |
| Water | The other part |

2. Way of brick manufacturing, that includes clay mixing with water and additives, billet forming, drying and burning differs with: component mixing is made at the proportion 75-80 mass % clay, 20-25 mass % water of the total amount of mixture, at the same time the 5% copolymer (MMA with 73-80%, molecular mass 800 000) water solution is added, and the billet burning process is made with the slow temperature growing followed by the 2 hours exposure at 800° C.
